(19) United States
(12) Patent Application Publication
(10) Pub. No.: US 2010/0089512 A1
(43) Pub. Date: Apr. 15, 2010

(54) PROCESS FOR PRODUCING AND STORING A SEMI-FINISHED PRODUCT MADE OF ELASTOMERIC MATERIAL

(76) Inventors: Francesca Baione, Milano (IT); Fabrizia Sala, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/448,201

(22) PCT Filed: Dec. 15, 2006
(86) PCT No.: PCT/EP2006/012106

§ 371 Date: Dec. 8, 2009

(51) Int. Cl. B60C 9/18; B29D 30/20; B29C 53/32

(52) U.S. Cl. 152/537; 156/117; 264/320

(57) ABSTRACT

A process for producing tyres for vehicle wheels includes the following steps: manufacturing a green tyre including at least one element made of crosslinkable elastomeric material, the element being obtained by unwinding a semi-finished product in strip form from a storage reel and then coiling the product onto a building drum; moulding the green tyre in a moulding cavity defined in a vulcanizing mould; crosslinking the elastomeric material by heating the tyre to a given temperature for a given time; wherein the element made of crosslinkable elastomeric material includes at least one copolymer of at least one ethylenically unsaturated carboxylic acid or a derivative thereof with at least one ethylenically unsaturated monomer containing at least one polyoxyalkylene side chain.

The present invention relates to a process for producing tyres comprising the step of unwinding a semi-finished product made of elastomeric material.

More particularly, the present invention relates to a process for producing tyres comprising the step of unwinding a semi-finished product previously prepared and stored in strip form made of crosslinkable elastomeric material.

In the present description and in the claims which follow, the expression “semi-finished product in strip form” means an elongate element which is of indefinite and predominant length compared with the other two dimensions (width and thickness), made of crosslinkable elastomeric material, of constant or variable thickness in the transverse direction of this semi-finished product, used, together with other elements, as a component of a rubber article.

Said semi-finished product may be a tape, that is to say an element consisting solely of elastomeric material, or a band, that is to say an element which comprises filiform reinforcing elements (threads, cords, fibres) at least partially embedded in an elastomeric material.

It is known that tyres can be prepared by a process including a plurality of manufacturing stages. More particularly, said process comprises the stages of preparing, beforehand and separately from each other, a series of semi-finished products corresponding to the various parts of the tyre such as, for example, one or more rubberized carcass plies, one or more belt strips, the tread, the side walls, the airtight layer made of elastomeric material (“liner”) which lines the inner surface of tyres intended for use without an inner tube (“tubeless” tyres), the sheet made of elastomeric material placed between the tread and the belt structure, the strips made of elastomeric material, of narrow width and variable transverse thickness, placed under the edges of the belt structure, or the tapes made of elastomeric material, of narrow width and constant thickness, folded around the edges of the belt strips. During the process for producing a tyre, the various semi-finished products made of elastomeric material which are combined to produce the finished tyre are fed, in a specific sequence of operating stages, into a manufacturing machine generally comprising at least one building drum on which the abovementioned semi-finished products are gradually positioned and assembled together, according to techniques that are well known in the art as described, for example, in patents GB 1 495 803 and U.S. Pat. No. 4,484,965.

The abovementioned semi-finished products are usually produced in the form of a continuous strip and, before being used in the course of the industrial production of tyres, are usually wound in the form of superimposed concentric coils around a cylindrical surface such as, for example, the core of a storage reel.

It should be pointed out here that the term “storage reel” is not intended to be limiting but is used, for the purpose of simplifying the description, to indicate any type of device for storing the semi-finished product which may be used as an alternative to said reel, such as, for example, a storage beam.

The winding-up onto storage reels is conventionally carried out using separating means made of antisticking material (for example polyethylene or polyester sheets) which prevent the wound coils from adhering together and then becoming extremely difficult, if not completely impossible, to be detached from each other, especially after a prolonged period of storage. In addition, the detachment of superimposed coils between which strong adhesive forces may have been created would require a strong tension to be exerted, which might change the geometrical dimensions of the semi-finished products, or even cause them to break.

Patent application WO 99/62695 describes a hybrid separating sheet with a different adhesiveness towards the non-vulcanized elastomeric material which needs to be stored on storage reels. As a matter of fact, during storage on a reel, the “stuck-to-liner” phenomenon may be encountered, that is to say that in the storage reel there may be points at which the non-vulcanized elastomeric material adheres too much to the separating sheet, thus causing subsequent problems in the unwinding of this material from the storage reel. To avoid the abovementioned phenomenon, a hybrid separating sheet is thus used, as mentioned above, in which the more expensive material (cotton) with low adhesiveness is used in the region of the storage reel (in particular in the innermost regions close to the core of the reel) where it is most likely that an excessive adhesion between said separating sheet and the elastomeric material will take place, while the less expensive material (polyester) is used in the regions of the storage reel (in particular—in the outermost regions of the reel) where there is little probability of excessive adhesion taking place between the separating sheet and the elastomeric material.

U.S. Pat. No. 5,004,635 relates to the use of a separating sheet of differing thickness, which, in addition to preventing adhesion phenomena between the coils of non-vulcanized elastomeric material wound on a storage reel, also prevents any crushing or distortion of said material. Said separating sheet consists of a base, for example polyethylene, a cover, for example polyester, and a compressible filling material placed between the base and the cover, for example polyester fibres.

However, based on the Applicant's experience, the use of separating means as described above has many drawbacks such as, for example: the presence of additional processing stages either during the production of the semi-finished product or during the process for manufacturing the finished product (application and subsequent removal of said separating sheet); the need to work at unwinding speeds that are not too high; the possibility of breakdowns in the machinery due to the presence of said separating sheet; the need for machinery dedicated to its application and subsequent removal. Said drawbacks have a negative impact both on the production costs and on the overall productivity, leading to an increase in the production times for the semi-finished product and the finished product.

The Applicant thus faced the problem of avoiding the use of said separating means. A first approach was disclosed in patent application WO 02/102566. Such patent application discloses the addition in the elastomeric material of a polyalkenamer able to reduce the adhesiveness of the crosslinkable elastomeric material of the semi-finished product without impairing the “green strength” of the semi-finished product and the adhesion of the elastomeric material with adjacent elements in the finished product.

The Applicant then realized that it was not only necessary to reduce the adhesiveness of the crosslinkable elastomeric material of the semi-finished product without impairing the “green strength” thereof, but that it was also necessary not to have a negative impact on the properties of said material, and in particular on the viscoelastic properties which would cause an increase of the hysteresis losses and as a consequence an increase of the energy dissipated by the rolling finished product.

The Applicant has now found that it is possible to overcome the drawbacks mentioned above and to wind up on storage reels semi-finished products made of crosslinkable elastomeric material, in particular for the production of tyres, without necessarily using separating sheets and without having a negative impact on the viscoelastic properties of said material.

The Applicant has found that the addition of at least one modified polycarboxylate, as defined hereinbelow, to the crosslinkable elastomeric material makes it possible to obtain a semi-finished product which can be wound onto a storage reel without using a separating sheet, and can be subsequently unwound from said reel without being lacerated, even when high unwinding speeds are used. In addition, said semi-finished product may be used in the process of manufacturing tyres without creating an increase of the hysteresis losses in the finished product.

According to a first aspect, the present invention thus relates to a process for producing tyres for vehicle wheels, said process comprising the following stages:
manufacturing a green tyre comprising at least one element made of crosslinkable elastomeric material, said element being obtained by unwinding a semi-finished product in strip form from a storage reel and then coiling said product onto a building drum;
moulding the green tyre in a moulding cavity defined in a vulcanizing mould;
crosslinking the elastomeric material by heating the tyre to a given temperature for a given time;
   wherein said element made of crosslinkable elastomeric material comprises at least one copolymer of at least one ethylenically unsaturated carboxylic acid or a derivative thereof with at least one ethylenically unsaturated monomer containing at least one polyoxyalkylene side chain.

According to one preferred embodiment, said unwinding is carried out at a speed of between 50 m/min and 400 m/min, preferably between 250 m/min and 350 m/min.

According to a further aspect, the present invention relates to a process for producing and storing a semi-finished product in strip form made of crosslinkable elastomeric material, which includes:
preparing an elastomeric composition;
moulding said elastomeric composition to obtain a semi-finished product in a strip form;
winding up said semi-finished product in a strip form on a storage reel;
   wherein at least one copolymer of at least one ethylenically unsaturated carboxylic acid or a derivative thereof with at least one ethylenically unsaturated monomer containing at least one polyoxyalkylene side chain is added during the stage of preparing said elastomeric composition.

According to one preferred embodiment, said semi-finished product is a tape consisting of a crosslinkable elastomeric composition comprising at least one copolymer of at least one ethylenically unsaturated carboxylic acid or a derivative thereof with at least one ethylenically unsaturated monomer containing at least one polyoxyalkylene side chain.

According to a further preferred embodiment, said semi-finished product is a band comprising filiform reinforcing elements (threads, cords, fibres) at least partially embedded in a crosslinkable elastomeric composition comprising at least one copolymer of at least one ethylenically unsaturated carboxylic acid or a derivative thereof with at least one ethylenically unsaturated monomer containing at least one polyoxyalkylene side chain.

In this case, the product is thus a composite elastomeric material comprising reinforcing cords made of textile, metal or other material. More particularly, said composite elastomeric material comprises reinforcing cords, typically made of textile (for example rayon, nylon, polyethylene terephthalate), or made of metal (for example steel threads which are stranded together, coated with a metal alloy, for example copper/zinc, zinc/manganese, zinc/molybdenum/cobalt alloys), or made of glass fibre, said cords being mutually parallel and on the same plane, and being coated and welded together with an elastomeric material of the desired thickness. Said reinforcing cords, thus arranged, are analogous to a textile warp, while the presence of the weft is optional since the elastomeric material which coats and welds them together also serves to maintain the arrangement.

According to a further aspect, the present invention relates to a tyre for vehicle wheels, comprising the following elements:
at least one rubberized carcass ply shaped in a substantially toroidal configuration, the opposite lateral edges of which are associated with respective right-hand and left-hand bead wires, each bead wire being enclosed in a respective bead;
a belt structure comprising at least one belt strip applied along the circumference of said rubberized carcass ply;
a tread applied along the circumference of said belt structure;
a reinforcing layer placed between said belt structure and said tread;
right-hand and left-hand side walls applied externally to said carcass ply, said side walls extending, in an axially external position, from the respective bead to the respective edge of the belt structure;
   in which said reinforcing layer placed between said belt structure and said tread comprises a plurality of reinforcing cords coated and welded together with a crosslinked elastomeric composition comprising at least one copolymer of at least one ethylenically unsaturated carboxylic acid or a derivative thereof with at least one ethylenically unsaturated monomer containing at least one polyoxyalkylene side chain. Preferably, said reinforcing cords comprise textile fibres.

According to a further aspect, the present invention relates to a tyre for vehicle wheels, comprising at least one element made of crosslinked elastomeric material which includes an elastomeric composition comprising at least one copolymer of at least one ethylenically unsaturated carboxylic acid or a derivative thereof with at least one ethylenically unsaturated monomer containing at least one polyoxyalkylene side chain, in which said element is obtained by unwinding a semi-finished product in strip form from a storage reel and then coiling said product onto a building drum.

According to one preferred embodiment said copolymer of at least one ethylenically unsaturated carboxylic acid or a derivative thereof with at least one ethylenically unsaturated monomer containing at least one polyoxyalkylene side chain (d) may be selected from compounds having the following general formula (I):

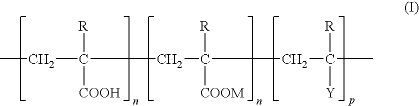

wherein:
R represents a hydrogen atom or a linear or branched C₁-C₄ alkyl group, preferably a methyl group;
M represents a monovalent or a divalent cation, preferably:
   an alkali metal cation, more preferably sodium or potassium;
   an alkaline-earth metal cation, more preferably calcium;
   an ammonium cation having formula N(R₁)₄ wherein R₁ groups, which may be equal or different from each other, are selected from: hydrogen atoms, linear or branched C₁-C₁₈ alkyl groups, C₆-C₁₈ aryl groups, C₇-C₂₁ arylalkyl or alkylaryl groups, more preferably NH₄;
   a zinc cation;
n is an integer of from 0 to 20, preferably of from 1 to 10, extremes included;
m and p, which may be equal or different from each other, are an integer of from 1 to 20, preferably of from 2 to 10, extremes included;
Y represents one of the groups having the following general formulae (II), (III) or (IV):

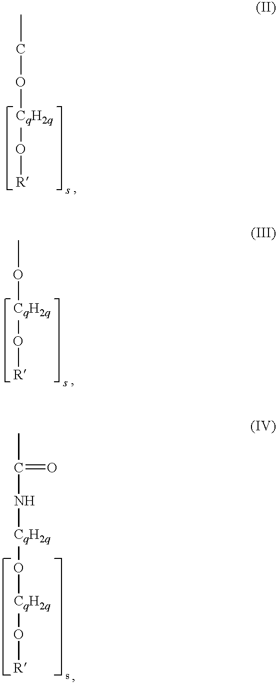

wherein:
R has the same meanings as above reported;
R′ represents a hydrogen atom; a linear or branched C₁-C₁₀ alkyl group, preferably a methyl group; a R″—SO₃M group, wherein R″ represents a linear or branched C₂-C₁₀ alkylene group, preferably a methylene group, and M has the same meanings as above reported;
q is an integer of from 1 to 10, preferably of from 1 to 5, extremes included;
s is an integer of from 1 to 100, preferably of from 4 to 50, extremes included.

According to one preferred embodiment, said copolymer of at least one ethylenically unsaturated carboxylic acid or a derivative thereof with at least one ethylenically unsaturated monomer containing at least one polyoxyalkylene side chain (d) has a weight-average molecular weight (Mw) of from 500 to 100,000, preferably of from 1,000 to 50,000, more preferably of from 2,000 to 30,000. Said weight average molecular weight (M_{w}) may be determined according to known techniques such as, for example, by gel permeation chromatography (GPC).

The copolymer of at least one ethylenically unsaturated carboxylic acid or a derivative thereof with at least one ethylenically unsaturated monomer containing at least one polyoxyalkylene side chain (d) above reported may be obtained by processes known in the art. For example, said copolymer may be obtained by the free-radical polymerization of about 1 wt % to 99 wt % of at least one unsaturated monocarboxylic or dicarboxylic acid or a derivative thereof (such as, for example, (meth)acrylic acid, maleic acid, maleic anhydride), with about 99 wt % to 1 wt % of at least one compound having the following general formula (V):

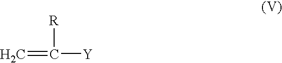

wherein R and Y have the same meanings as above reported.

The copolymers so obtained may be further reacted with alkali metal hydroxides, alkaline-earth metal hydroxides, zinc hydroxide, or ammonium compounds.

Said copolymers may be terminated with hydrogen atoms or residues of the polymerization iniziators usually used such as, for example, peroxides, persulfates, azo-type iniziators.

Further details about the processes for producing said copolymers may be found, for example, in International Patent Application WO 03/106369, in U.S. Pat. No. 5,798,425 and U.S. Pat. No. 5,632,324, or in United States Patent Application US 2003/0144384.

Examples of copolymers of at least one ethylenically unsaturated carboxylic acid or a derivative thereof with at least one ethylenically unsaturated monomer containing at least one polyoxyalkylene side chain (d) which may be used in the present invention and which are currently commercially available are the products Melflux® from Degussa (in particular, Melflux® PP100, Melflux® VP2651, Melflux®1641), Narlex® from Alco Chemical (in particular, Narlex® D36, Narlex® D38), Peramin® Conpac S149 from Perstorp.

For the purpose of the present description and the claims, the expression “phr” is intended to indicate the parts by weight of a given component of the elastomeric composition per 100 parts by weight of polymer base, which includes at least one elastomeric polymer as defined below and at least one polyalkenamer as defined above.

The elastomeric composition which may be used according to the present invention also comprises at least one elastomeric polymer chosen from natural or synthetic rubbers with elastomeric properties, chosen from: natural rubber; homopolymers and copolymers of butadiene, of isoprene or of 2-chlorobutadiene, such as, for example, polybutadiene (BR), polyisoprene (IR), styrene-butadiene (SBR), nitrile-butadiene (NBR), polychloroprene (CR); ethylene/propylene copolymers (EPM); ethylene/propylene/non-conjugated diene (such as, for example, norbornene, cyclooctadiene or dicyclopentadiene) terpolymers (EPDM); or mixtures thereof. The following are preferred: natural rubber, styrene/butadiene (SBR), nitrile-butadiene (NBR), polychloroprene (CR), ethylene/propylene copolymers (EPM), ethylene/propylene/non-conjugated diene (such as, for example, norbornene, cyclooctadiene or dicyclopentadiene) terpolymers (EPDM), or mixtures thereof.

Said elastomeric composition may also comprise a sulphur-based vulcanizing system chosen from those commonly used for diene elastomers, generally comprising a sulphur-based vulcanizing agent together with one or more vulcanization activators and/or accelerators.

The vulcanizing agent most advantageously used is sulphur, or molecules containing sulphur (sulphur donors), with accelerators and activators that are known to those skilled in the art.

Activators that are particularly effective are zinc compounds and in particular ZnO, ZnCO₃ and zinc salts of saturated or unsaturated fatty acids containing from 8 to 18 carbon atoms, such as, for example, zinc stearate, which are preferably formed in situ in the blend from ZnO and fatty acid. Other activators may be chosen from: BiO, PbO, Pb₃O₄, PbO₂ and mixtures thereof.

Accelerators commonly used may be chosen from: dithiocarbamates, guanidine, thiourea, thiazoles, sulphenamides, thiurams, amines, xanthates and the like, or mixtures thereof.

In addition, said elastomeric composition may comprise at least one reinforcing filler (for example carbon black, silica, alumina, aluminosilicates, calcium carbonate, kaolin and the like, or mixtures thereof), in addition to other conventional components such as antioxidants, anti-ageing agents, protective agents, plasticizers, compatibilizers for the reinforcing filler, adhesives, anti-ozone agents, modifying resins, lubricants (for example mineral oils, vegetable oils, synthetic oils and the like, or mixtures thereof).

The crosslinkable elastomeric composition which may be used according to the present invention may be prepared according to the processes known in the art. For example, said preparation may be carried out by mixing together the various ingredients which are chosen as a function of the particular semi-finished product which it is desired to obtain. The mixing can be carried out, for example, using an open blender of open-mill type or an internal blender of the type with tangential rotors (Banbury) or interlocking rotors (Intermix), or in continuous blenders of the Ko-Kneader (Buss) type or co-rotating or counter-rotating twin-screw type. The operating conditions under which the process is performed also depend on the type of ingredients which need to be mixed together and are known to those skilled in the art.

Once the crosslinkable elastomeric composition has been prepared, said composition is moulded so as to obtain a semi-finished product in strip form, for example in the form of a tape or band. The moulding of the elastomeric material may be carried out by straining, profiling, calendering or extrusion. The operating conditions under which the process is performed depend on the particular semi-finished product which it is desired to obtain and are known to those skilled in the art. In the case of moulding a band, as mentioned above, it is necessary to bring about coupling between the elastomeric material and the reinforcing elements (threads, cords or fibres): in this case also, the techniques used and the operating conditions under which the process is performed depend on the particular semi-finished product which it is desired to obtain and are known to those skilled in the art.

The semi-finished product in strip form made of crosslinkable elastomeric material which is thus obtained is then subjected to a stage of cooling which may be carried out in various ways such as, for example: immersing said semi-finished product in a cooling liquid, for example water at room temperature; or passing said semi-finished product over a series of coiled tubes in which cold water circulates.

Once cooled, the semi-finished product in strip form made of elastomeric material is wound on a storage reel.

At the time of use, the abovementioned semi-finished product wound on the storage reel can be unwound and used without any problems arising.

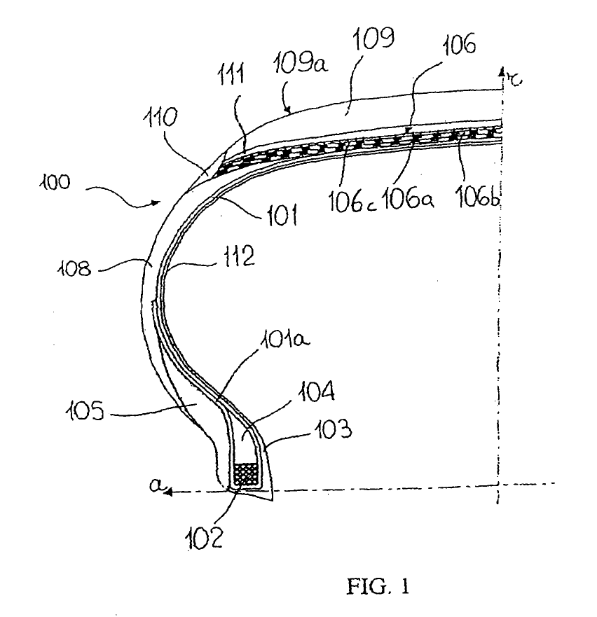

The present invention will now be illustrated in further detail by means of a number of illustrative embodiments, with reference to the attached FIG. 1, which is a view in cross section of a portion of a tyre made according to the invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one rubberized carcass ply (101), the opposite lateral edges of which are associated with respective bead wires (102). The association between the carcass ply (101) and the bead wires (102) is usually achieved by folding back the opposite lateral edges of the carcass ply (101) around the bead wires (102) so as to form the so-called carcass back-folds (101a) as shown in FIG. 1.

Alternatively, the conventional bead wires (102) can be replaced with a pair of circumferentially inextensible annular inserts formed from elongate elements arranged in concentric coils (not represented in FIG. 1) (see, for example, European patent applications EP 928 680 and EP 928 702). In this case, the carcass ply (101) is not back-folded around said annular inserts, the coupling being provided by a second carcass ply (not represented in FIG. 1) applied externally over the first.

The rubberized carcass ply (101) generally consists of a plurality of reinforcing cords arranged parallel to each other and at least partially coated with a layer of elastomeric material. These reinforcing cords are usually made of textiles (for example rayon, nylon or polyethylene terephthalate). In some cases, said reinforcing cords are cords made of metal (for example steel threads stranded together), coated with a metal alloy (for example copper/zinc, zinc/manganese, zinc/molybdenum/cobalt alloys and the like).

The rubberized carcass ply (101) is usually of radial type, i.e. it incorporates reinforcing cords arranged in a substantially perpendicular direction relative to a circumferential direction. Each bead wire (102) is encased in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) in which the bead wires (102) are embedded. An antiabrasive strip (105) is usually placed in an axially external position relative to the carcass back-fold (101a).

A belt structure (106) is applied along the circumference of the rubberized carcass ply (101). In the specific embodiment in FIG. 1, the belt structure (106) comprises two belt strips (106a, 106b) which incorporate a plurality of reinforcing cords, typically metal cords, parallel to each other in each strip and intersecting with respect to the adjacent strip, oriented so as to form a predetermined angle relative to a circumferential direction. The belt structure (106) can optionally comprise at least one reinforcing layer (106c) at zero degrees, commonly known as a “0° band”, which can be produced according to the invention, placed on the radially outermost belt strip (106b), which generally incorporates a plurality of reinforcing cords, typically textile cords, arranged at an angle of a few degrees relative to a circumferential direction, and coated and welded together by means of an elastomeric material.

A side wall (108) is also applied externally onto the rubberized carcass ply (101), this side wall extending, in an axially external position, from the bead (103) to the edge of the belt structure (106).

A tread (109), whose lateral edges meet the side walls (108), is applied circumferentially in a position radially external to the belt structure (106). Externally, the tread (109) has a rolling surface (109a) designed to come into contact with the ground. Circumferential grooves linked by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the zone of the join between the side walls (108) and the tread (109), this mini-side wall generally being obtained by co-extrusion with the tread and allowing an improvement in the mechanical interaction between the tread (109) and the side walls (108). Alternatively, the end portion of the side wall (108) directly covers the lateral edge of the tread (109). A underlayer which forms, with the tread (109), a structure commonly known as a “cap and base” (not represented in FIG. 1) may optionally be placed between the belt structure (106) and the tread (109).

A layer of elastomeric material (111) which serves as an “attachment sheet”, i.e. a sheet capable of providing the connection between the tread (109) and the belt structure (106), may be placed between the tread (109) and the belt structure (106).

In the case of tubeless tyres, a rubber layer (112) generally known as a “liner”, which provides the necessary impermeability to the inflation air of the tyre, may also be provided in a radially internal position relative to the rubberized carcass ply (101).

The process for producing the tyre according to the present invention can be carried out according to techniques and using apparatus that are known in the art, as described, for example, in patents EP 199 064, U.S. Pat. No. 4,872,822 and U.S. Pat. No. 4,768,937, said process including at least one stage of manufacturing the green tyre and at least one stage of vulcanizing this tyre.

More particularly, the process for producing the tyre comprises the stages of preparing, beforehand and separately from each other, a series of semi-finished products corresponding to the various parts of the tyre which are then combined together using a suitable manufacturing machine, as defined above. The green tyre thus obtained is then passed to the subsequent stages of moulding and vulcanization. To this end, a vulcanization mould is used which is designed to receive the tyre being processed inside a moulding cavity having countermoulded walls which define the outer surface of the tyre when the crosslinking is complete.

Alternative processes for producing a tyre or parts of a tyre without using semi-finished products are disclosed, for example, in the abovementioned patent applications EP 928 680 and EP 928 702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an expandable vulcanization chamber, by providing inside the tyre a toroidal metal support shaped according to the configuration of the inner surface of the tyre to be obtained (as described, for example, in patent EP 242,840). The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

The present invention will be further illustrated below by means of a number of preparation examples, which are given for purely indicative purposes and without any limitation of this invention.

### EXAMPLES 1-3

The compositions given in Table 1 were prepared as follows (the amounts are given in phr).

All the components given in Table 1, except for the sulphur, CTP, HMMM and DCBS, were mixed together in an internal blender of the laboratory type with tangential rotors (Banbury) model PL 1.6 from Pomini, rotated at about 75 rpm. After about 3 minutes and, in any case, as soon as the temperature reached 150° C., said composition was discharged from the blender (1st stage).

After cooling to room temperature (about 23° C.), said composition was placed in a laboratory open-mill blender and the remaining components, i.e. ZnO, sulphur, CTP, HMMM and DCBS, were added (2nd stage). The composition was discharged from said blender when the temperature reached 90° C.

TABLE 1

| | | | |
|---|---|---|---|
| INGREDIENTS | Ex. 1(*) | Ex. 2(*) | Ex. 3 |

1st stage

| | | | |
|---|---|---|---|
| NR | 70 | 60 | 70 |
| BR | 30 | 30 | 30 |
| Vestenamer ® | — | 10 | — |
| 8012 | | | |
| Melflux ® PP100 | — | — | 2.5 |
| N326 | 55 | 55 | 55 |
| Stearic acid | 1 | 1 | 1 |
| Rhenogran | 1 | 1 | 1 |
| Resorcinol ® 80 | | | |
| 6-PPD | 1 | 1 | 1 |
| Zinc oxide | 5 | 5 | 5 |

2nd stage

| | | | |
|---|---|---|---|
| 33% insoluble | 5.5 | 5.5 | 5.5 |
| sulphur | | | |
| CTP | 0.1 | 0.1 | 0.1 |
| HMMM | 2 | 2 | 2 |
| DCBS | 1 | 1 | 1 |

(*)comparative.
NR: natural rubber;
BR: butadiene rubber;
Vestenamer ® 8012: polyoctenamer from Degussa-Hüls;
Melflux ® PP100: copolymer of partially salified (meth)acrylic acid monomers with ethylenically unsaturated monomers containing polyoxyethylene side chains (Degussa);
N326: carbon black;
Rhenogran Resorcinol ® 80: 80% resorcinol supported with a polymeric excipient, from Rhein-Chemie (adhesion promoting agent);
6-PPD: para-phenylenediamine, Santoflex ® 13 from Monsanto (protective agent);
33% insoluble sulphur: Crystex ® OT33 from Flexsys;
CTP: cyclohexylthiophthalimide, Vulkalent ® G from Bayer (retardant);
HMMM: hexamethoxymethylenemelamine, Cyrez ® 963 from Cytec (methylene donor);
DCBS: N,N′-Dicyclohexyl-2-benzothiazole sulfenamide (accelerator).

The following tests were carried out on the compositions thus prepared.

### Tests on Green Product

The following were measured in the non-crosslinked compositions obtained as described above:
“scorch time” at 127° C. according to ISO standard 289/1;
Mooney viscosity ML (1+4) at 100° C. according to ISO standard 289/1;
density at 23° C. according to ISO standard 2781.

The data obtained are given in Table 2.

### Tests on Vulcanized Product

### (a) Rheometric Properties

The compositions obtained as described above were subsequently subjected to MDR rheometric analysis (according to ISO standard 6502) using an MDR rheometer from Monsanto, the tests being carried out at 170° C. for minutes, with an oscillation frequency of 1.66 Hz (100 oscillations per minute) and an oscillation amplitude of ±0.5°, measuring the time required to achieve an increase of 1 and 2 rheometric units (TS1 and TS2) and the time required to reach 30%, 60%, and 90% of the final torque value (T30, T60, and T90). The data obtained are given in Table 2.

### (b) Static Mechanical Properties and Hardness

The following were measured on samples of the compositions obtained as described above, crosslinked at 170° C. for 10 minutes:
the tensile mechanical properties according to ISO standard 37 (CA0.5=stress at break at 50% elongation; CA1=stress at break at 100% elongation; CR=stress at break);
the hardness in IRHD degrees according to ISO standard 48.

### (c) Dynamic Mechanical Properties

The dynamic mechanical properties were measured using an Instron dynamic device in the traction-compression mode according to the following methods. A test piece of the crosslinked elastomeric composition obtained as disclosed above (vulcanized at 170° C. for 10 min) having a cylindrical form (length=25 mm; diameter=14 mm), compression-preloaded up to a 25% longitudinal deformation with respect to the initial length, and kept at the prefixed temperature (23° C. or 70° C.) for the whole duration of the test, was submitted to a dynamic sinusoidal strain having an amplitude of ±3.5% with respect to the length under pre-load, with a 100 Hz frequency. The dynamic mechanical properties are expressed in terms of dynamic elastic modulus (E') and Tan delta (loss factor) values. The Tan delta value is calculated as a ratio between viscous modulus (E″) and elastic modulus (E′).

The data obtained are given in Table 2.

TABLE 2

| PROPERTIES | Ex. 1 (*) | Ex. 2 (*) | Ex. 3 |
|---|---|---|---|
| Scorch time MS at | 9.1 | 13.2 | 14 |
| 127° C. (min.) | | | |
| Mooney ML (1 + 4) at | 71.7 | 61.4 | 62.4 |
| 100° C. | | | |
| Density | 1.178 | 1.177 | 1.178 |
| (g/cm³) | | | |
| CA0.5 (MPa) | 2.0 | 2.1 | 2.2 |
| CA1 (MPa) | 3.75 | 3.86 | 4.25 |
| CR (MPa) | 12.34 | 10.00 | 14.17 |
| IRHD (23° C.) | 74.0 | 76.2 | 75.4 |
| T30 (min.) | 1.97 | 1.93 | 1.85 |
| T60 (min.) | 3.21 | 3.16 | 2.97 |
| T90 (min.) | 5.80 | 5.75 | 5.35 |
| TS2 (min.) | 1.01 | 1.00 | 1.00 |
| E′ (23° C.) | 7.625 | 8.560 | 7.818 |
| E′ (70° C.) | 6.718 | 7.200 | 7.088 |
| ΔE′ | 0.91 | 1.36 | 0.73 |
| Tan delta (23° C.) | 0.123 | 0.165 | 0.129 |
| Tan delta (70° C.) | 0.085 | 0.104 | 0.077 |

(*) = comparative

### Adhesion Tests

The compositions of Examples 1-3 were extruded using a laboratory single-screw extruder described in ASTM standard D2230-96e1, equipped with a die with a rectangular outlet cross section having the following dimensions: 4 mm×35 mm, working under the following conditions:
rotation speed of the screw: 90 rpm;
temperature profile constant at 90° C.

Strips were obtained which were allowed to cool to room temperature (about 23° C.) for 4 hours. Next, from said strips rectangular test pieces were obtained which had the following dimensions: 40 mm×35 mm, which were subjected to the adhesion test using a Chatillon Model DPP-100N force meter in traction and compression.

To this end, two test pieces were used for each composition to be tested. The test pieces were applied between the clamps of said forcemeter, taking care, before closing the two clamps together, to place a separating sheet made of perforated polyethylene (diameter of the hole: 11 mm) between the two test pieces, so as to ensure a constant cross section of contact between them. The surfaces of the two test pieces were placed in contact by applying a load equal to 40 N, in compression, for 10 seconds. At the end of the 10 seconds, the load was removed and the minimum force required to detach the two surfaces was measured in Newtons (N) using a force meter. The data obtained are given in Table 3.

The data obtained are given in Table 3.

TABLE 3

| | | |
|---|---|---|
| Ex. 1 (*) | Ex. 2 (*) | Ex. 3 |

ADHESION (N)

| | | |
|---|---|---|
| 24.72 | 13.46 | 9.72 |

(*) = comparative.

1-25. (canceled)

26. A process for producing tyres for vehicle wheels, comprising the following stages:
manufacturing a green tyre comprising at least one element made of crosslinkable elastomeric material comprising at least one copolymer of at least one ethylenically unsaturated carboxylic acid or a derivative thereof with at least one ethylenically unsaturated monomer containing at least one polyoxyalkylene side chain, said element being obtained by unwinding a semi-finished product in strip form from a storage reel and then coiling said product onto a building drum;
moulding the green tyre in a moulding cavity defined in a vulcanizing mould; and
crosslinking the elastomeric material by heating the tyre to a given temperature for a given time.

27. The process according to claim 26, wherein the unwinding is carried out at a speed of 50 m/min to 400 m/min.

28. The process according to claim 27, wherein the unwinding is carried out at a speed of 250 m/min to 350 m/min.

29. The process according to claim 26, wherein said copolymer of at least one ethylenically unsaturated carboxylic acid or a derivative thereof with at least one ethylenically unsaturated monomer containing at least one polyoxyalkylene side chain is selected from compounds having the following general formula (I): 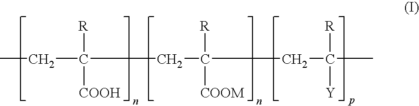
wherein:
R represents a hydrogen atom or a linear or branched C₁-C₄ alkyl group;
M represents a monovalent or a divalent cation;
n is an integer of from 0 to 20 extremes included;
m and p, which may be the same or different from each other, are an integer of from 1 to 20 extremes included; and
Y represents one of the groups having the following general formulae (II), (III) or (IV): 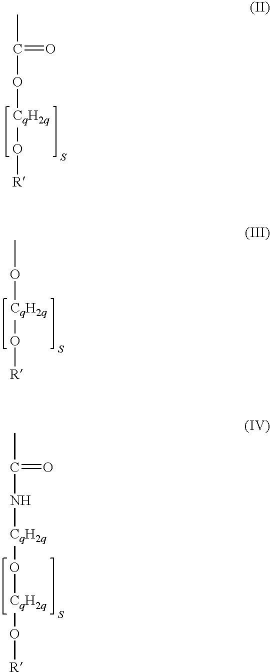
wherein:
R has the same meanings as above;
R′ represents a hydrogen atom; a linear or branched C₁-C₁₀ alkyl group; or a R″—SO₃M group, wherein R″ represents a linear or branched C₂-C₁₀ alkylene group and M has the same meanings as above;
q is an integer of from 1 to 10 extremes included; and
s is an integer of from 1 to 100 extremes included.

30. The process according to claim 29, wherein, in said compounds having general formula (I), M represents:
an alkali metal cation;
an alkaline-earth metal cation;
an ammonium cation having formula N(R₁)₄ wherein R₁ groups, which may be the same or different from each other, are selected from: hydrogen atoms, linear or branched C₁-C₁₈ alkyl groups, C₆-C₁₈ aryl groups, C₇-C₂₁ arylalkyl and alkylaryl groups; or
a zinc cation.

31. The process according to claim 26, wherein said copolymer of at least one ethylenically unsaturated carboxylic acid or a derivative thereof with at least one ethylenically unsaturated monomer containing at least one polyoxyalkylene side chain has a weight-average molecular weight of 500 to 100,000.

32. The process according to claim 31, wherein said copolymer of at least one ethylenically unsaturated carboxylic acid or a derivative thereof with at least one ethylenically unsaturated monomer containing at least one polyoxyalkylene side chain has a weight-average molecular weight of 1,000 to 50,000.

33. The process according to claim 32, wherein said copolymer of at least one ethylenically unsaturated carboxylic acid or a derivative thereof with at least one ethylenically unsaturated monomer containing at least one polyoxyalkylene side chain has a weight-average molecular weight of 2,000 to 30,000.

34. The process according to claim 26, wherein said copolymer of at least one ethylenically unsaturated carboxylic acid or a derivative thereof with at least one ethylenically unsaturated monomer containing at least one polyoxyalkylene side chain is present in an amount of 3 phr to 40 phr.

35. The process according to claim 34, wherein said copolymer of at least one ethylenically unsaturated carboxylic acid or a derivative thereof with at least one ethylenically unsaturated monomer containing at least one polyoxyalkylene side chain is present in an amount of 5 phr to 30 phr.

36. The process according to claim 35, wherein said copolymer of at least one ethylenically unsaturated carboxylic acid or a derivative thereof with at least one ethylenically unsaturated monomer containing at least one polyoxyalkylene side chain is present in an amount of 8 phr to 25 phr.

37. The process according to claim 26, wherein the elastomeric composition comprises at least one elastomeric polymer selected from: natural rubber; homopolymers and copolymers of butadiene, homopolymers and copolymers of isoprene, homopolymers and copolymers of 2-chlorobutadiene, polybutadiene, polyisoprene, styrene-butadiene, nitrile-butadiene, polychloroprene; ethylene/propylene copolymers; ethylene/propylene/non-conjugated diene terpolymers; or mixtures thereof.

38. The process according to claim 37, wherein the elastomeric polymer is selected from: natural rubber, styrene-butadiene, nitrile-butadiene, polychloroprene, ethylene/propylene copolymers, ethylene/propylene/non-conjugated diene terpolymers, or mixtures thereof.

39. A process for producing and storing a semi-finished product in strip form made of crosslinkable elastomeric material, comprising:
preparing an elastomeric composition comprising adding thereto at least one ethylenically unsaturated carboxylic acid or a derivative thereof with at least one ethylenically unsaturated monomer containing at least one polyoxyalkylene side chain;
moulding said elastomeric composition to obtain a semi-finished product in strip form; and
winding said semi-finished product in strip form on a storage reel.

40. The process according to claim 39, wherein the semi-finished product is a tape consisting of a crosslinkable elastomeric composition comprising at least one copolymer of at least one ethylenically unsaturated carboxylic acid or a derivative thereof with at least one ethylenically unsaturated monomer containing at least one polyoxyalkylene side chain.

41. The process according to claim 39, wherein the semi-finished product is a band comprising filiform reinforcing elements at least partially embedded in a crosslinkable elastomeric composition comprising at least one copolymer of at least one ethylenically unsaturated carboxylic acid or a derivative thereof with at least one ethylenically unsaturated monomer containing at least one polyoxyalkylene side chain.

42. The process according to claim 39, wherein said at least one copolymer of at least one ethylenically unsaturated carboxylic acid or a derivative thereof with at least one ethylenically unsaturated monomer containing at least one polyoxyalkylene side chain is selected from compounds having the following general formula (I): 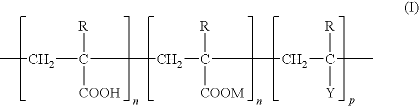
wherein:
R represents a hydrogen atom or a linear or branched C₁-C₄ alkyl group;
M represents a monovalent or a divalent cation;
n is an integer of from 0 to 20 extremes included;
m and p, which may be the same or different from each other, are an integer of from 1 to 20 extremes included; and
Y represents one of the groups having the following general formulae (II), (III) or (IV): 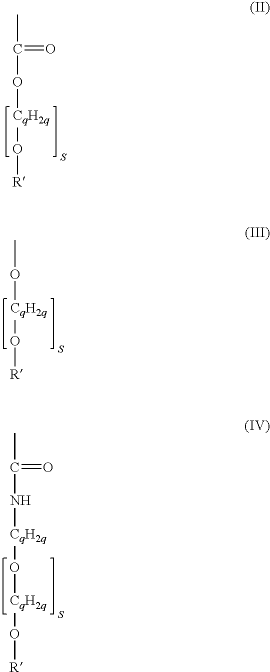
wherein:
R has the same meanings as above;
R′ represents a hydrogen atom; a linear or branched C₁-C₁₀ alkyl group; or a R″—SO₃M group, wherein R″ represents a linear or branched C₂-C₁₀ alkylene group and M has the same meanings as above;
q is an integer of from 1 to 10 extremes included; and
s is an integer of from 1 to 100 extremes included; or
contains at least one polyoxyalkylene side chain having a weight-average molecular weight of 500 to 100,000; or
is present in an amount of 3 phr to 40 phr.

43. The process according to claim 49, wherein the elastomeric composition comprises at least one elastomeric polymer selected from: natural rubber; homopolymers and copolymers of butadiene, homopolymers and copolymers of isoprene or homopolymers and copolymers of 2-chlorobutadiene, polybutadiene, polyisoprene, styrene-butadiene, nitrile-butadiene, polychloroprene; ethylene/propylene copolymers; ethylene/propylene/non-conjugated diene terpolymers; or mixtures thereof.

44. A tyre for vehicle wheels, comprising the following elements:
at least one rubberized carcass ply shaped in a substantially toroidal configuration, opposite lateral edges of which are associated with respective right-hand and left-hand bead wires, each bead wire being enclosed in a respective bead;
a belt structure comprising at least one belt strip applied along the circumference of said rubberized carcass ply;
a tread applied along the circumference of said belt structure;
a reinforcing layer comprising a plurality of reinforcing cords coated and welded together with a crosslinked elastomeric composition comprising at least one copolymer of at least one ethylenically unsaturated carboxylic acid or a derivative thereof with at least one ethylenically unsaturated monomer containing at least one polyoxyalkylene side chain and placed between said belt structure and said tread; and
right-hand and left-hand side walls applied externally to said carcass ply, said side walls extending, in an axially external position, from a respective bead to a respective edge of the belt structure.

45. The tyre for vehicle wheels according to claim 44, wherein the reinforcing cords consist of textile fibres.

46. The tyre for vehicle wheels according to claim 44, wherein said at least one copolymer of at least one ethylenically unsaturated carboxylic acid or a derivative thereof with at least one ethylenically unsaturated monomer containing at least one polyoxyalkylene side chain is selected from compounds having the following general formula (I): 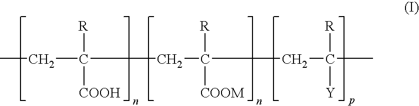
wherein:
R represents a hydrogen atom or a linear or branched C₁-C₄ alkyl group;
M represents a monovalent or a divalent cation;
n is an integer of from 0 to 20 extremes included;
m and p, which may be the same or different from each other, are an integer of from 1 to 20 extremes included; and
Y represents one of the groups having the following general formulae (II), (III) or (IV): 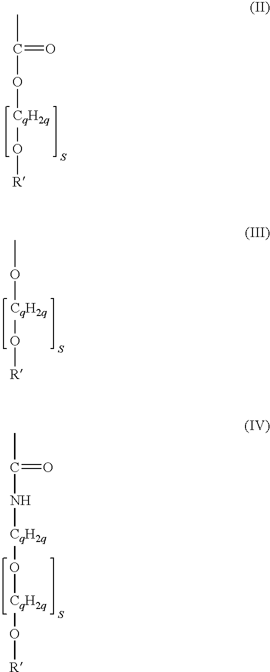
wherein:
R has the same meanings as above;
R′ represents a hydrogen atom; a linear or branched C₁-C₁₀ alkyl group; or a R″—SO₃M group, wherein R″ represents a linear or branched C₂-C₁₀ alkylene group and M has the same meanings as above;
q is an integer of from 1 to 10 extremes included; and
s is an integer of from 1 to 100 extremes included; or
contains at least one polyoxyalkylene side chain having a weight-average molecular weight of 500 to 100,000; or
is present in an amount of 3 phr to 40 phr.

47. The tyre for vehicle wheels according to claim 44, wherein the elastomeric composition comprises at least one elastomeric polymer selected from: natural rubber; homopolymers and copolymers of butadiene, homopolymers and copolymers of isoprene or homopolymers and copolymers of 2-chlorobutadiene, polybutadiene, polyisoprene, styrene-butadiene, nitrile-butadiene, polychloroprene; ethylene/propylene copolymers; ethylene/propylene/non-conjugated diene terpolymers; or mixtures thereof.

48. A tyre for vehicle wheels, comprising at least one component made of crosslinked elastomeric material comprising an elastomeric composition comprising at least one copolymer of at least one ethylenically unsaturated carboxylic acid or a derivative thereof with at least one ethylenically unsaturated monomer containing at least one polyoxyalkylene side chain, wherein said component is obtained by unwinding a semi-finished product in strip form from a storage reel and then coiling said product onto a building drum.

49. The tyre for vehicle wheels according to claim 48, wherein said at least one copolymer of at least one ethylenically unsaturated carboxylic acid or a derivative thereof with at least one ethylenically unsaturated monomer containing at least one polyoxyalkylene side chain is selected from compounds having the following general formula (I): 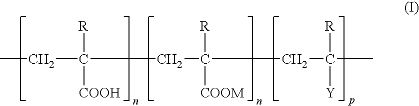
wherein:
R represents a hydrogen atom or a linear or branched C₁-C₄ alkyl group;
M represents a monovalent or a divalent cation;
n is an integer of from 0 to 20 extremes included;
m and p, which may be the same or different from each other, are an integer of from 1 to 20 extremes included; and
Y represents one of the groups having the following general formulae (II), (III) or (IV): 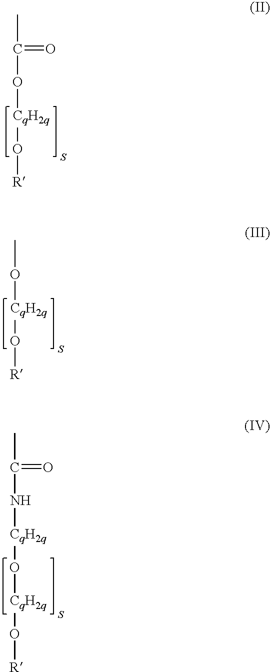
wherein:
R has the same meanings as above;
R′ represents a hydrogen atom; a linear or branched C₁-C₁₀ alkyl group; or a R″—SO₃M group, wherein R″ represents a linear or branched C₂-C₁₀ alkylene group and M has the same meanings as above;
q is an integer of from 1 to 10 extremes included; and
s is an integer of from 1 to 100 extremes included; or
contains at least one polyoxyalkylene side chain having a weight-average molecular weight of 500 to 100,000; or
is present in an amount of 3 phr to 40 phr.

50. The tyre for vehicle wheels according to claim 48, wherein the elastomeric composition comprises at least one elastomeric polymer selected from: natural rubber; homopolymers and copolymers of butadiene, homopolymers and copolymers of isoprene or homopolymers and copolymers of 2-chlorobutadiene, polybutadiene, polyisoprene, styrene-butadiene, nitrile-butadiene, polychloroprene; ethylene/propylene copolymers; ethylene/propylene/non-conjugated diene terpolymers; or mixtures thereof.
